(19) United States
(12) Patent Application Publication
(10) Pub. No.: US 2014/0188977 A1
(43) Pub. Date: Jul. 3, 2014

(54) APPRATUS, METHOD FOR DEPLOYING APPLICATIONS IN A VIRTUAL DESKTOP INTERFACE SYSTEM

(71) Applicant: FUTUREWEI TECHNOLOGIES, INC., Plano, TX (US)

(72) Inventors: Zhexuan Song, Sunnyvale, CA (US); HengLiang Zhang, Cupertino, CA (US)

(73) Assignee: FUTUREWEI TECHNOLOGIES, INC., Plano, TX (US)

(21) Appl. No.: 13/730,329

(22) Filed: Dec. 28, 2012

(51) Int. Cl. H04L 29/08

(52) U.S. Cl. CPC H04L 67/10
USPC 709/203

(57) ABSTRACT

In a VDI session, an application is dynamically deployed in a host server or a client device to achieve improved performance. The host server establishes a VDI session with the client device and executes an application in response to a request from the client device. The host server determines, based on a set of performance parameters associated with the VDI session, that the client device is to take over the execution of the application. Execution of the application is then suspended, and state data of the application is collected when the application is suspended. Thereafter, the host server sends an instruction and the state data to the client device to instruct the client device to resume execution of the application from a state defined by the state data.

### TECHNICAL FIELD

The invention generally relates to desktop virtualization, and more specifically to dynamically deploy applications at a server or a client device for desktop virtualization.

### BACKGROUND

Virtual Desktop Infrastructure (VDI), sometimes referred to as virtual desktop interface, is now used by many organizations to provide a more flexible option to address the varying needs of their users. With desktop virtualization, a user's computing environment (e.g., operating system, applications, and/or user settings) may be separated from the user's physical computing device (e.g., smartphone, laptop, and desktop computer). Thus, a “virtualized desktop” may be presented by a remote central server to a client device, rather than in the local storage of the client device, and applications presented in the virtual desktop may be executed by the remote central server at the request of the client device. Such applications may include, for example, enterprise software, accounting software, office suites, graphics software and media players, etc. Applications in the virtual desktop are usually installed and executed in the server. The server generates an display image and communicates it to a client device for display via a VDI protocol, e.g. Windows Remote Desktop (RDP), Citrix HDX 3D, Red Hat Simple Protocol for Independent Computing Environment (SPICE), Sun Appliance Link Protocol (ALP), Teradici PC-over-IP (PCoIP) and HP Remote Graphics Software (RGS), etc.

### SUMMARY

It is an object of the invention to provide a method and a host server for dynamically deploying applications in the host server or a client device in a virtual desktop interface (VDI) session.

An embodiment of the invention provides a host server. The host server for providing VDI services comprises a memory having computer executable instructions stored therein; and a processor coupled with the memory. The processor is configured to execute the computer executable instructions to establish a virtual desktop interface (VDI) session with a client device via a network, including presenting a virtual desktop for display by the client device. The processor executes an application in response to a request from the client device within the VDI session to execute the application and determines, based on a set of performance parameters associated with the VDI session, that the client device is to take over the execution of the application. Based upon the determination, the processor suspends execution of the application and collects state data of the application when the application is suspended. Then, the processor sends an instruction and the state data to the client device to instruct the client device to resume execution of the application from a state defined by the state data.

Another embodiment of the present invention provides a method. The method performed by a host server for providing VDI services comprises the following steps: establishing a virtual desktop interface (VDI) session with a client device via a network, including presenting a virtual desktop for display by the client device; executing an application in response to a request from the client device within the VDI session to execute the application; determining, based on a set of performance parameters associated with the VDI session, that the client device is to take over the execution of the application; suspending execution of the application and collect state data of the application when the application is suspended; and sending an instruction and the state data to the client device to instruct the client device to resume execution of the application from a state defined by the state data.

Another embodiment provides a host server. The host server for providing VDI services comprises a memory having computer executable instructions stored therein; and a processor coupled with the memory. The processor is configured to execute the computer executable instructions to establish a VDI session with a client device via a network, including presenting a virtual desktop for display by the client device and instruct the client device to execute an application based upon a request from the client device within the VDI session to execute the application. The processor further determines, based on a set of performance parameters associated with the VDI session, that the host server is to take over the execution of the application. Then the processor sends an instruction to instruct the client device to suspend execution of the application and collect state data of the application when the application is suspended by the client device, and receive the state data of the application from the client device. The processor executes the application from a state defined by the state data received from the client device.

Another embodiment of the present invention provides a method. The method performed by a host server for providing VDI services comprises the following steps: establishing a VDI session with a client device via a network, including presenting a virtual desktop for display by the client device; instructing the client device to execute an application based upon a request from the client device within the VDI session to execute the application; determining, based on a set of performance parameters associated with the VDI session, that the host server is to take over the execution of the application; sending, an instruction to instruct the client device to suspend execution of the application and collect state data of the application when the application is suspended by the client device; receiving the state data of the application from the client device; and executing the application from a state defined by the state data received from the client device.

Example host servers or methods provided herein determine to execute an application at a host server or a client device based upon one or more collected performance parameters. And the application is migrated between host server and client device dynamically according to the determination. Performance parameters associated with VDI session are considered in selecting a device for executing the application. Thus, optimized performance may be achieved.

### BRIEF DESCRIPTION OF THE DRAWINGS

FIG. 1 is a block diagram showing a Virtual Desktop Interface (VDI) system with a host server hosting VDI sessions for a plurality of client devices on a network;

FIG. 2 is a block diagram showing a host server in a VDI session with a client device to provide virtual desktops;

FIG. 3 is a flow chart depicting a process for deploying an application in a client device; and

FIG. 4 is a flow chart depicting a process for deploying an application in a host server.

### DETAILED DESCRIPTION

Virtual Desktop Infrastructure (VDI) is the practice of hosting a desktop operating system for a client device within a virtual machine running on a host server, which may be a centralized server communicating remotely over a network with the client device. To provide the VDI service, the host server establishes a VDI session with the client device and presents a virtual desktop, which is displayed by the client device for viewing by the user of the client device. Applications in the virtual desktop may be installed and executed in the host server or installed and executed locally in the client device according to a pre-configured policy.

During a VDI session, when an application is being executed, many factors can affect the performance of the execution as perceived by the user, and the original assignment of the application execution (by the server or by the client) might not provide the best performance due to changed conditions. In embodiments of the invention, in order to achieve better performance, an application currently executed by the host server may need to be transferred to the client device for continued execution. Similarly, an application currently executed by a client device may need to be transferred back to the host server for further execution. For example, when the bandwidth of the network between the client device and the host server degrades, data transportation between the host server and the client device may slow down. In this situation, if the application is still executed by the host server, the performance may degrade because the VDI session relies on the network to transmit display images of the application to the client device. Instead, if the application is executed by the client device locally, less data need to be transmitted, and the performance of the application may be improved. In another example, if the performance of the host server degrades due to increased workload, each virtual desktop in the host server receives less computing time, and may not be able respond to user operations in a timely manner, thereby creating a bad user experience. In that case, if some computation-intensive applications are migrated to the client device, the client may obtain results faster. At the same time, the server load is reduced and may be able to provide better services for other client devices.

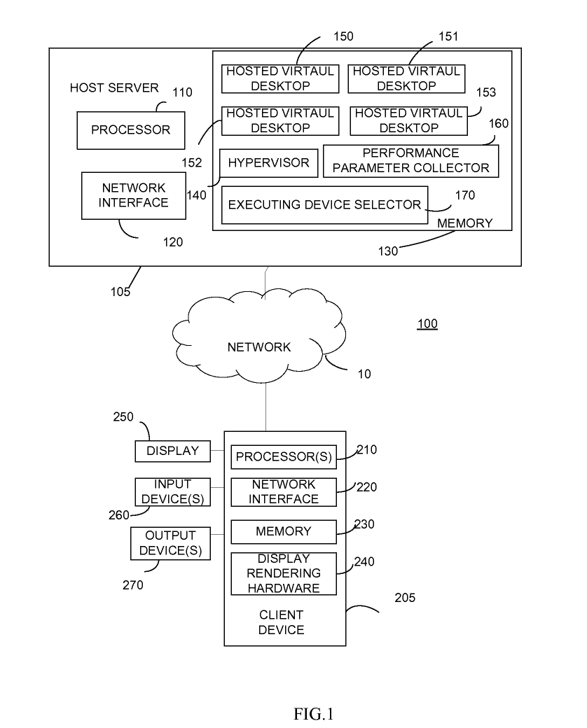

Referring now to the FIG. 1, a block diagram showing an embodiment of a VDI environment 100. As shown in FIG. 1, the VDI environment 100 includes a host server 105 and a client device 205, which are connected over a network 10 to each other. The VDI environment 100 may include additional host servers, client devices, and other devices not shown.

The network 10 represents any hardware and/or software configured to communicate information via any suitable communications media (e.g., WAN, LAN, Internet, Intranet, wired, wireless, etc.), and may include routers, hubs, switches, gateways, or any other suitable components in any suitable form or arrangement. The various components of the VDI environment 100 include any conventional or other communications devices to communicate over the networks via any conventional or other protocols, and may utilize any type of connection (e.g., wired, wireless, etc.) for access to the network.

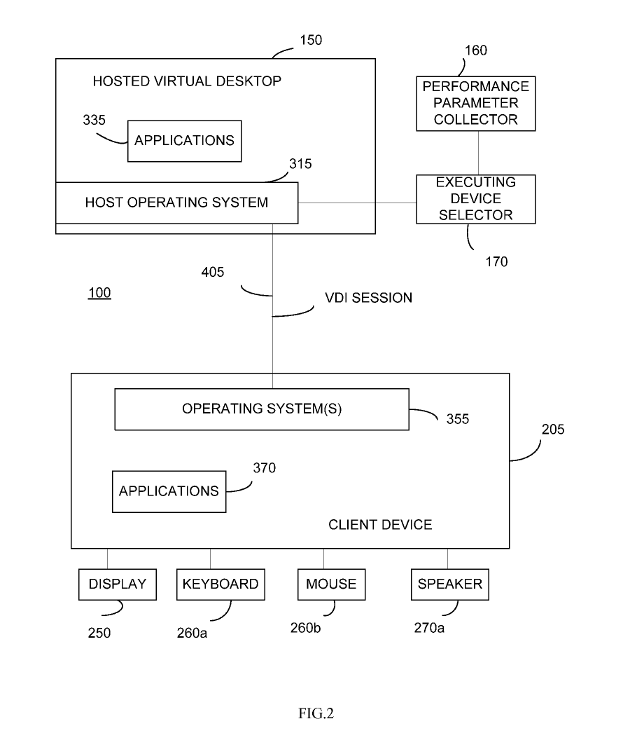

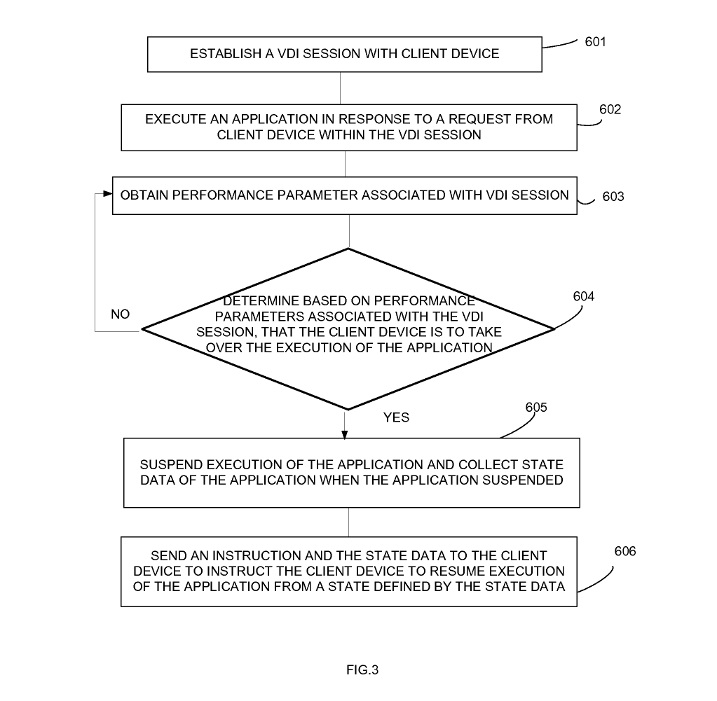

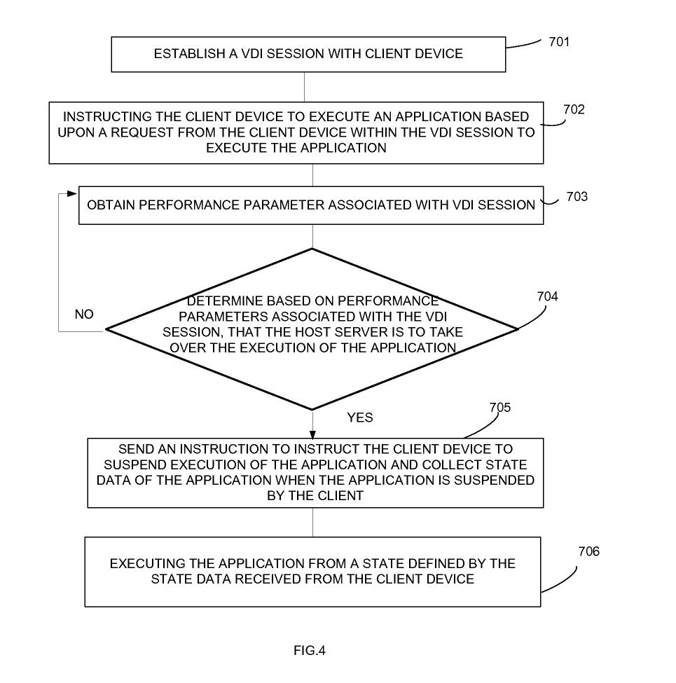

The host server 105 comprises a processor 110, a network interface 120, and a memory 130. The processor 110 may be implemented by multiple processors. The processor 110 is a data processing device such as a microprocessor, microcontroller, system on a chip (SOC), or other fixed or programmable logic, that executes instructions for process logic stored in the memory 130. The network interface 120 enables communication throughout the VDI environment 100, as shown in FIGS. 1 and 2. The memory 130 may be implemented by any conventional or other memory or storage device, and may include any suitable storage capacity. The memory 130 comprises read only memory (ROM), random access memory (RAM), erasable programmable read-only memory (EPROM), magnetic disk storage media devices, optical storage media devices, flash memory devices, electrical, optical, or other physical/tangible memory storage devices. The memory 130 may comprise one or more computer readable storage media (e.g., a memory device) encoded with software comprising computer executable instructions and when the software is executed (by the processor 110) it is operable to perform the operations described herein in connection with FIGS. 3 and 4.

The host server 105 may be a computing blade, a blade server comprising one or more solid state drives, or a blade center comprising one or more blade servers together with a blade chassis comprising common resources such as networking connections, input/output device connections, power connections, cooling devices, switches, etc. The host server 105 may be a component of a larger system, or a data center that centralizes enterprise computing resources.

Resident in the memory 130 is a hypervisor 140, multiple virtual desktops 150, 151, 152, and 153, a performance parameter collector 160, and an executing device selector 170. The hypervisor or virtual machine monitor 140 presents a virtual operating platform to the virtual desktops 150, 151, 152, and 153, and manages access to the host processor 110, the network interface 120, the memory 130 and other host resources, so that the virtual desktops 150, 151, 152, and 153 have access to appropriate host resources without disrupting each other's operation. A virtual desktop operates independently of the other virtual desktops and runs as a separate virtual machine on the host server 105, and different virtual desktop may run a different operating system if desired. Further operations of the virtual desktops are explained below with reference to FIGS. 2, 3 and 4. The performance parameter collector 160 is operable to obtain performance parameter. The performance parameter includes one or more of: a type of the application, client device performance indices such as processor utilization, IO utilization, host server performance indices such as processor utilization, IO utilization, bandwidth of the network, a physical location of the client device, and a network connection type of the client device, etc. The performance parameter collector 160 may be part of the hypervisor 140, or a peer component linked to the hypervisor 140. The executing device selector 170 selects a device from the host server 105 and the client device 205 to execute an application according to performance parameter obtained by the performance parameter collector 160. The executing device selector 170 may be part of the hypervisor 140, or a peer component connected to the hypervisor 140.

The client device 205 comprises a processor 210, a network interface 220, a memory 230, and a display rendering hardware 240. The processor 210 is, for example, a data processing device such as a microprocessor, microcontroller, system on a chip (SOC), or other fixed or programmable logic, that executes instructions for process logic stored in the memory 230. The network interface 220 enables communication throughout the VDI environment 100, as shown in FIGS. 1 and 2. The memory 230 may be implemented by any conventional or other memory or storage device, and may include any suitable storage capacity. The memory 230 may comprise read only memory (ROM), random access memory (RAM), erasable programmable read-only memory (EPROM), magnetic disk storage media devices, optical storage media devices, flash memory devices, electrical, optical, or other physical/tangible memory storage devices. The memory 230 may comprise one or more computer readable storage media (e.g., a memory device) encoded with software comprising computer executable instructions and when the software is executed (by the processor 210) it is operable to perform the operations described herein in connection with FIGS. 3 and 4. The display rendering hardware 240 may be a part of the processor 210, or may be, e.g., a separate graphics processor, e.g., a Graphics Processor Unit (GPU). Resident in the memory 230 is one or more application(s).

The client device 205 may be any conventional or other computer system or device, such as a thin client, a computer terminal or a workstation, a personal desktop computer, a laptop or a net book, a tablet, a cellular phone, a set-top box, a networked television, or other device capable of acting as a client device in VDI environment 100.

The client device 205 interfaces with a display device 250, an input device(s) 260, and an output device(s) 270, and communicates with these devices in any suitable fashion, e.g., via a wired or wireless connection. The display device 250 may be any suitable display, a screen or a monitor capable of displaying information to a user of the client device 205, for example a screen of a tablet or a monitor attached to a computer workstation. The input device(s) 260 may include any suitable input device, for example, a keyboard, a mouse, a track pad, a touch input tablet, a touch screen, a camera, a microphone, a remote control, a speech synthesizer, or the like. The output device(s) 270 may include any suitable output device, for example, a speaker, a headphone, a sound output port, or the like. The display device 250, the input device(s) 260 and the output device(s) 270 may be separated devices, e.g., a monitor used in conjunction with a microphone and speakers, or may be combined, e.g., a touch screen that is a display and an input device, or a headset that is both an input (e.g., via the microphone) and output (e.g., via the speakers) device.

The functions of the processors 110 and 210 may each be implemented by a processor or computer readable tangible (non-transitory) medium encoded with instructions or by logic encoded in one or more tangible media (e.g., embedded logic such as an application specific integrated circuit (ASIC), digital signal processor (DSP) instructions, software that is executed by a processor, etc.), wherein the memories 130 and 230 each store data used for the computations or functions described herein (and/or to store software or processor instructions that are executed to carry out the computations or functions described herein). Alternatively, one or more computer readable storage media are provided and encoded with software comprising computer executable instructions and when the software is executed operable to performing the techniques described herein.

FIG. 2 is a block diagram showing the host server 105 in a VDI session 405 with the client device 205. For purposes of simplification, the other components of the VDI environment 100, e.g., other client devices, are not shown here. Further, although the description refers to the interaction between the virtual desktop 150 and the client device 205, it is understood by those skilled in the art that the virtual desktop 150 may interact with one or more client devices, and the client device 205 may interact with one or more virtual desktops on a single or multiple host servers.

The virtual desktop 150 comprises a host operating system 315 and one or more application(s) 335. The client device 205 comprises a operating system 355, and one or more application 370, all of which reside in the memory 230 (as shown in FIG. 1), and also comprises the display 250, the input devices 260 including a keyboard 260a and a mouse 260b, and the output device 270 including a speaker 270a.

The host operating system 315 provides virtual desktop interface functionality to the client device 205 over the VDI session 405, which is a VDI protocol link that is established using any suitable VDI protocol, for example Citrix Independent Computing Architecture (ICA), VMWare PC over IP (PCoIP), Microsoft Remote Desktop Protocol (RDP), or other suitable protocol. If an application is executed by the host server 105, the application with which a user of the client device 205 is interacting is hosted by the virtual desktop 150, while the window associated with the application is rendered by the client device 205. The host operating system 315 may send virtual desktop display to the client device 205 as a virtual desktop display over the VDI session 405. The VDI session 405 represents the virtual desktop display as an image.

The client device 205 also receives user inputs from the input devices 260. For example, an application is being executed by the host server 105, the user types on the keyboard 260a or exercises the mouse 260b, and these inputs are translated by the operating system 355 and sent to the host operating system 315 via the VDI session 405. After it receives the user input, the host operating system 315 translates them into virtual keyboard and mouse inputs, and feeds them to the application, as if the applications and the input devices 260 were running on a single desktop computing device. The user inputs are processed by the application at the virtual desktop, and virtual desktop display images are generated by the operating system 315 for transmitting back to the client device 205, which renders the virtual desktop display for display to the user on display 250.

In another example, an application is executed by the client device 205. The user types on keyboard 260a or exercises mouse 260b, and these inputs are translated by the operating system 355 and fed to the executing application. Or these inputs are translated by the operating system 355, and then sent to the host operating system 315 via the VDI session 405. After it receives the user input, the host operating system 315 translates it into virtual keyboard and mouse inputs, and sent them back to the operating system 355 via the VDI session 405. The user inputs are processed by the application, and display images are generated by the operating system 355 for display to the user on display 250.

FIG. 3 shows a flow chart depicting a process for deploying an application which is currently executed by the host server 105 to the client device 205.

At step 601, the host server 105 establishes the VDI session 405 with the client 205 via network 10. The VDI session represents the virtual desktop 150 display as an image for display by the client device 205.

At step 602, the host server 105 executes an application in the virtual desktop 150 in response to a request from the client device 205 within the VDI session 405 to execute the application. For example, a user initials a spreadsheet application via the client device 205. The host server 105 executes the spreadsheet application in the virtual desktop 150 in response to a request from the client device 205 and sends virtual display to the client device 205 over the VDI session 405.

At step 603, during the application is being executed, the performance parameter collector 160 in the host server 105 obtains one or more performance parameters which are associated with the VDI session 405. The one or more performance parameters associated with the VDI session 405 are capable of affecting the performance of the application as perceived by a user of the client device 205. Specific performance parameter which would be obtained by the performance parameter collector 160 is configured beforehand.

The one or more performance parameters may be collected in a pre-configured interval. For example, a network connection type of the client device 205 may be retrieved every minute, the host server performance indices may be retrieved every minute.

At step 604, the executing device selector 170 of the host server 105 determines a selected device to execute the application based on a set of performance parameters obtained by the performance parameter collector 160. If the selected device is currently executing the application, no change need to be made and the performance parameter collector 160 keeps on obtaining performance parameters. Otherwise, if the selected device is not executing the application, then the selected device is to take over the execution of the application. At this step, the selected device may be the client device 205 which is not currently executing the application.

An example for making the determination is provided herewith. The application in the virtual desktop 150 has one or more minimum requirements regarding the performance parameters to be executed at the host server 105, which is defined in a policy linked with the application. If the executing device selector 170 determines that one or more minimum requirements are not met based on performance parameters obtained by the performance parameter collector 160, it will trigger the migration process to have the client device 205 executed the application.

Another example is that the executing device selector 170 measures and grades one or more performance parameters collected by the performance parameter collector 160. If there are multiple performance parameters being graded, the executing device selector 170 uses a formula to calculate an index number according to the grades of the performance parameters. The executing device selector 170 further compares the index number with a pre-configured threshold and makes the determination based upon the comparison. For example, if the index number is higher than a preconfigured threshold, the selected device is the host server 105; otherwise, the selected device is the client device 205. The executing device selector 170 may calculate an average grade of the graded performance parameters and compare the average grade to a pre-configured threshold. Accordingly, the executing device selector 170 determines a selected device based upon the comparison.

In particular, a performance parameter is graded with a scale 0-10, which indicates the inclination degree for running the application on the client device 205 or the host server 105. On the scale 0-10, 0 means the application is highly recommended to be run by the client device, 10 means the application is highly recommended to be run by the host server 105, 5 means both the client device and the host server are equally acceptable.

At step 605, the host server 105 suspends execution of the application and collects state data of the application when the application is suspended. The state data of the application includes information for enabling an operating system to resume execution of the application. For example, the state data of the application includes one or more of the following: memory page where the application and related data are stored, central processing unit (CPU) register values which record the current state of the application, and stack state where the temporary data are stored, etc.

At step 606, the host server 105 sends an instruction and the state data to the client device 205 to instruct the client device 205 to resume execution of the application from a state defined by the state data. The client device 205 executes the application according to the state data received from the host server 105. The application is also installed in the client device 205. When the client device 205 receives the instruction and the state data from the host server 105, the client device 205 launches the application installed in the client device 205, copies the current state into memory, and resumes execution of the application according to the state data.

The interruption between the transition could be short enough that user does not realize the migration. After the state data being sent, the host server 105 may close the application in the host server 105. The client device 105 displays the image retrieved from the application in the client device 205.

FIG. 4 shows a flow chart depicting a process for deploying an application which is currently executed by the client device 205 to the host server 105.

At step 701, the host server 105 establishes the VDI session 405 with the client 205 via network 10. The VDI session represents the virtual desktop 150 display as an image for display by the client device 205.

At step 702, the host device instructs the client device 205 to execute an application in the virtual desktop 150 in response to a request from the client device 205 within the VDI session 405 to execute the application. For example, the client device 205 sends an execution request to the host server 205 when a user initials a spreadsheet application via the client device 205. The host server 105 redirect the execution request to the client device 205 to instruct the client device 205 to execute the spreadsheet application.

At step 703, during the application is being executed, the performance parameter collector 160 in the host server 105 obtains a set of performance parameters which is associated with the VDI session 405. The set of performance parameters associated with the VDI session 405 is capable of affecting the performance of the application as perceived by a user of the client device 205. Specific performance parameter which would be obtained by the performance parameter collector 160 is configured beforehand.

At step 704, the executing device selector 170 of the host server 105 determines a selected device to execute the application based on a set of performance parameters obtained by the performance parameter collector 160. If the selected device is currently executing the application, no change need to be made and the performance parameter collector 160 keeps on obtaining performance parameters. Otherwise, if the selected device is not executing the application, then the selected device is to take over the execution of the application. At this step, the selected device may be the host server 105 which is not currently executing the application.

An example for making the determination is provided herewith. The application in the virtual desktop 150 has one or more minimum requirements regarding the performance parameters to be executed at the client device 205, which is defined in a policy linked with the application. If the executing device selector 170 determines that one or more minimum requirements are not met based on performance parameters obtained by the performance parameter collector 160, it will trigger the migration process to have the host device 105 executed the application.

At step 705, the host server 105 sends an instruction to instruct the client device to suspend execution of the application and collect state data of the application when the application is suspended by the client. The client device 205 suspends execution of the application and collects state data of the application when the application is suspended. The state data of the application includes information for enabling an operating system to resume execution of the application. For example, the state data of the application includes one or more of the following: memory page where the application and related data are stored, central processing unit (CPU) register values which record the current state of the application, and stack state where the temporary data are stored, etc.

At step 706, the host server 105 receives the state data from the client device 205 and executing the application from a state defined by the state data to resume execution of the application. The application is also installed in the host server 105. When the host server 105 receives the state data from the client device 205, the host server 105 launches the application installed in the host server 105, copies the current state into memory, and executes the application according to the state data.

The interruption between the transition could be short enough that user does not realize the migration. After the state data being sent, the client device 205 may close the application in the client device 205. The client device 105 displays the image retrieved from the host server 105.

In summary, the host server 105 provided herein determine to execute an application at the host server 105 or client device 205 based upon one or more collected performance parameters. And the application is migrated between the host server 105 and client device 205 dynamically according to the determination. Performance parameters associated with VDI session are considered in selecting a device for executing the application. Thus, optimized performance may be achieved.

With respect to the Figures, which illustrate the architecture, functionality, and operation of possible implementations of methods, apparatuses, and computer readable media encoded with instructions, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometime be executed in the reverse order, depending on the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A host server on a network for providing virtual desktop interface (VDI) services, comprising:
a memory having computer executable instructions stored therein; and
a processor coupled with the memory and configured to execute the computer executable instructions to:
establish a VDI session with a client device via a network, including presenting a virtual desktop for display by the client device;
execute an application in response to a request from the client device within the VDI session to execute the application;
determine, based on a set of performance parameters associated with the VDI session, that the client device is to take over the execution of the application;
suspend execution of the application and collect state data of the application when the application is suspended; and
send an instruction and the state data to the client device to instruct the client device to resume execution of the application from a state defined by the state data.

2. The host server according to claim 1, wherein the set of performance parameters comprises one or more factors selected from: a type of the application, client device performance indices, host server performance indices, bandwidth of the network, a physical location of the client device, and a network connection type of the client device.

3. The host server according to claim 2, wherein the processor is configured to collect the set of performance parameters at a pre-configured interval.

4. The host server according to claim 1, wherein the processor determines that the client device is to take over the execution of the application when one or more minimum requirements for executing the application on the host server are not met based upon the set of performance parameters.

5. The host server according to claim 1, wherein the processor determines that the client device is to take over the execution of the application by:
grading one or more performance parameters obtained;
calculating an index number according to the one or more graded performance parameters;
comparing the index number with a pre-configured threshold; and
determining that the client is to take over the execution of the application based on the comparison.

6. The host server according to claim 1, wherein the processor is further configured to:
receive a response from the client device indicating that the application in the client device has resumed execution of application.

7. A method performed by a host service on a network to provide virtual desktop interface (VDI) services, comprising:
establishing a virtual desktop interface session with a client device via a network, including presenting a virtual desktop for display by the client device;
executing an application in response to a request from the client device within the VDI session to execute the application;
determining, based on a set of performance parameters associated with the VDI session, that the client device is to take over the execution of the application;
suspending execution of the application and collect state data of the application when the application is suspended; and
sending an instruction and the state data to the client device to instruct the client device to resume execution of the application from a state defined by the state data.

8. The method according to claim 7, wherein the set of performance parameters comprises one or more factors selected from: a type of the application, client device performance indices, host server performance indices, bandwidth of the network, a physical location of the client device, and a network connection type of the client device.

9. The method according to claim 8, wherein each factor in the set of performance parameters are collected in a pre-configured interval.

10. The method according to claim 7, wherein the host server determining that the client device is to take over the execution of the application when one or more minimum requirements are not met based upon the set of performance parameters.

11. The method according to claim 7, wherein the step of determining that the client device is to take over the execution of the application comprises:
grading one or more performance parameters obtained;
calculating an index number according to the one or more graded performance parameters;
comparing the index number with a pre-configured threshold; and
determining that the client is to take over the execution of the application based on the comparison.

12. A host server on a network for providing virtual desktop interface (VDI) services, comprising:
a memory having computer executable instructions stored therein; and
a processor coupled with the memory and configured to execute the computer executable instructions to:
establish a VDI session with a client device via a network, including presenting a virtual desktop for display by the client device;
instruct the client device to execute an application based upon a request from the client device within the VDI session to execute the application;
determine, based on a set of performance parameters associated with the VDI session, that the host server is to take over the execution of the application;
send, an instruction to instruct the client device to suspend execution of the application and collect state data of the application when the application is suspended by the client device;
receive the state data of the application from the client device; and
execute the application from a state defined by the state data received from the client device.

13. The host server according to claim 12, wherein the set of performance parameters comprises one or more factors selected from: a type of the application, client device performance indices, host server performance indices, bandwidth of the network, a physical location of the client device, and a network connection type of the client device.

14. The host server according to claim 13, wherein the processor is configured to collect the set of performance parameters at a pre-configured interval.

15. The host server according to claim 12, wherein the processor determines that the host server is to take over the execution of the application when one or more minimum requirements for executing the application on the client device are not met based upon the set of performance parameters.

16. The host server according to claim 12, wherein the processor determines that the host server is to take over the execution of the application by:
grading one or more performance parameters obtained;
calculating an index number according to the one or more graded performance parameters;
comparing the index number with a pre-configured threshold; and
determining that the client is to take over the execution of the application based on the comparison.

17. A method performed by a host service on a network to provide virtual desktop interface (VDI) services, comprising:
establishing a VDI session with a client device via a network, including presenting a virtual desktop for display by the client device;
instructing the client device to execute an application based upon a request from the client device within the VDI session to execute the application;
determining, based on a set of performance parameters associated with the VDI session, that the host server is to take over the execution of the application;
sending, an instruction to instruct the client device to suspend execution of the application and collect state data of the application when the application is suspended by the client device;
receiving the state data of the application from the client device; and
executing the application from a state defined by the state data received from the client device.

18. The method according to claim 17, wherein the set of performance parameters comprises one or more factors selected from: a type of the application, client device performance indices, host server performance indices, bandwidth of the network, a physical location of the client device, and a network connection type of the client device.

19. The method according to claim 17, wherein the host server determining that the host server is to take over the execution of the application when one or more minimum requirements for executing the application on the client device are not met based upon the set of performance parameters.

20. The method according to claim 17, wherein the step of determining that the host server is to take over the execution of the application comprises:
grading one or more performance parameters obtained;
calculating an index number according to the one or more graded performance parameters;
comparing the index number with a pre-configured threshold; and
determining that the client is to take over the execution of the application based on the comparison.
